(19) United States
(12) Patent Application Publication
(10) Pub. No.: US 2007/0102337 A1
(43) Pub. Date: May 10, 2007

(54) Deep bed filter

(76) Inventor: Gene Hirs, Atlantis, FL (US)

Correspondence Address: L.C. Begin & Associates, PLLC, 510 Highland Avenue, PMB 403, Milford, MI, 48381, US

(21) Appl. No.: 11/269,353

(22) Filed: Nov. 8, 2005

(51) Int. Cl. B01D 24/00

(52) U.S. Cl. 210/275; 210/290

(57) ABSTRACT

A deep bed filter principally used for filtration of contaminated aqueous fluid comprises a top layer of polymeric cylindrical particles in combination with at least one layer of sand. The polymeric cylindrical particles are approximately 1.5 millimeters in diameter and in one embodiment range 6-12 millimeters in length, with a specific gravity of approximately 1.15. When the filter is backwashed, sand particles mix with a portion of the polymeric particle layer, thereby creating larger surface voids for penetration of larger contaminant particles into the filter.

### FIELD OF THE INVENTION

This instant invention is generally related to deep bed filtration systems as described in U.S. Pat. Nos. 3,814,247, 3,900,395, 4,048,068, 4,197,205 and 4,197,208, all to Hirs.

### BACKGROUND OF THE INVENTION

The instant invention relates generally to an improved deep-bed filter used for filtering water, sewage or other aqueous liquids, and specifically to an improved apparatus and method for liquid filtration utilizing a polymeric filtration media layer for enhanced contaminant filtration with minimum pressure drop through the filter.

Typical deep bed filters often have difficulty handling peak or emergency loads without over-design of the filter or the addition of an auxiliary filter to handle the extra contaminant load. Simply adding layers of filtration media to existing deep bed filters to solve the aforementioned problems is ineffective. Furthermore, backwashing many prior art filters having media of varying particle sizes but identical specific gravities results in a reversal of the media grading order, i.e., from small to large.

This reverse gradation problem has been solved to some degree by using media materials having differing specific gravities. However, even when using materials of such different specific gravities as anthracite and sand, if the granules of coal are large enough they will stratify at lower levels within the filter bed. These aforementioned dual media filters are generally used to handle increased turbidity loads and will provide longer periods of filter operation between backwashing. However, when turbidity gets very high and coagulants must be used these filters are still subject to surface binding, thereby requiring frequent backwashing.

The primary problem with known in the art dual media deep bed filters is that large coagulated particles and floc that are larger than the voids in the top layers of media are captured at the surface instead of passing into the depth of the media. This buildup of surface contaminants on the filter causes pressure buildup on the filter surface, thereby restricting flow of high turbidity liquids and preventing effective use of adequate chemical flocculating agents. Furthermore, during filter backwashing media classification takes place and the coal fines settle at the surface of the filter, thereby closing off any voids and further restricting fluid flow through the filter. Increased relative turbidity is often the result.

### SUMMARY OF THE INVENTION

The instant invention utilizes an additional filtration media layer that is both larger and lighter than sand disposed below. This upper media layer mixes with the sand to enhance and maintain interstitial sites at the filter surface and throughout the mixed strata. Furthermore, this media is comprised of a plurality of cylindrical polymeric particles, each cylinder having a carefully selected diameter to maximize mixing with the finer sand particles subsequent to filter backwashing. This uppermost media strata prevents excessive buildup of contaminants on the surface of the deep bed filter, thereby enhancing fluid flow therethrough, even during periods of high contaminant loading. Other uses and advantages of the instant invention will become apparent from the detailed description of the preferred embodiments below in conjunction with the accompanying drawing Figures.

### BRIEF DESCRIPTION OF THE DRAWINGS

FIG. 1 is a schematic view of a prior art deep bed filter and a deep bed filter in accordance with the instant invention.

FIG. 2 is a graph of deep bed filter performance curves, in accordance with the present invention.

### DETAILED DESCRIPTION OF THE PREFERRED EMBODIMENTS

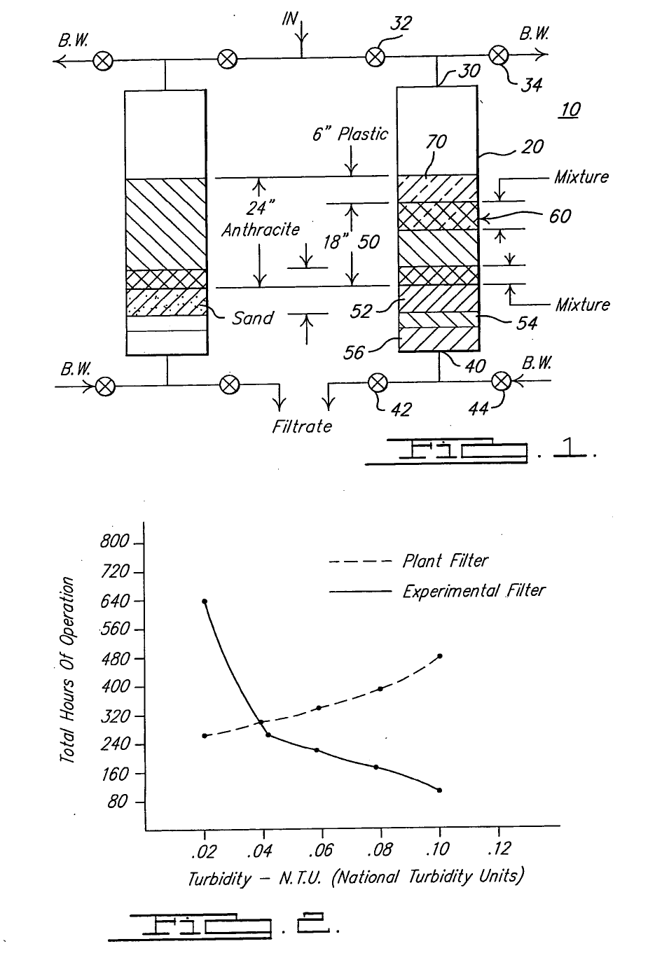

Referring now to FIG. 1 and in accordance with a preferred embodiment of the instant invention an improved deep bed filter 10 comprises a vessel 20 having a fluid inlet 30 and a fluid outlet 40. The vessel 20 may be any known in the art filter container or containment area capable of accepting a contaminant to be filtered. The inlet 30 supplies contaminated fluid to the filter 10, and is in fluid communication with an inlet valve 32 and an outlet backwash valve 34. Similarly, the outlet 40 is in fluid communication with both an outlet valve 42 and an inlet backwash valve 44. When filter 10 backwashing is desired, both the inlet and outlet valves 32, and 42 respectively, are closed, and both backwash valves 34 and 44 are opened, to allow fluid to be pumped from the bottom of the filter 10 to the top thereof.

The vessel 20 contains a plurality of layers of filter media including a layer of sand 50 over which is placed a layer of polymeric particles 70. The filter media typically contains large granular particles for example, below the filter sand 50. The polymeric particles 70 are cylindrical in shape, having a diameter of about 1.5 mm and a length of about 6 to 12 mm. Furthermore, in one embodiment, the polymeric particles 70 may have a specific gravity of approximately 1.15. The cylindrical shape and specific gravity of the particles 70 are selected to allow settling thereof at a rate which permits mixing with the finer sand particles 50 as the filter media layers settle subsequent to backwashing.

The cylindrical polymeric particles 70 mix well with the lower layer of sand particles 50 to form an intermediate layer 60 containing polymeric media and sand particles. This feature of the instant invention provides a significant improvement over prior art deep bed filtration systems.

Since the upper portion of the sand particles 50 tend to be relatively small, filter 10 surface loading often occurs around this area of the filter when high concentrations of organic contaminants or chemical flocs are present in the fluid to be filtered. The mixing action of the cylindrical polymeric particles 70 with the finer sand particles 50 creates a plurality of voids or interstices forming the intermediate layer 60. These voids permit contaminant penetration into the filter 10, thereby greatly enhancing filter efficiency due to significantly decreased surface loading.

The selection of size, shape, and specific gravity of the polymeric particles 70 is crucial to proper filter operation. The polymeric particle 70 characteristics are selected to provide a desired amount of mixing with the sand 50 to facilitate filter penetration. For example, prior art spherical polymeric particles are less desirable for use in deep bed filters because the rate of settling of a sphere is too great, thereby causing the particles to settle to the filter bottom. In one embodiment, the layer 70 ranges from 6 to 12 inches in the filter.

Since a cylinder has a higher area to volume ratio than a corresponding spherical particle, and therefore settles at a much slower rate, cylindrical particles are superior for use as a top media layer. Furthermore, polymeric particles having a specific gravity of 1.15 have an ideal settling rate to facilitate mixing with the sand particles 50, wherein exemplary sand particles range from 45-55 mm. Specifically, nylon or polypropylene composite rods having a specific gravity of 1.15 are commercially available and are readily cut into cylindrical particles 70 of appropriate size.

In one embodiment, a plurality of sand layers may be formed within the filter 10. As shown in FIG. 1, the first filtering sand layer 50 may be sized at 45-55 mm particles. A second supporting sand layer 52 may be formed beneath first sand layer 50, wherein sand layer 52 is formed with medium sand particles larger in size than first sand layer 50. A third supporting sand layer 54 may be formed beneath the second supporting sand layer 52, wherein sand layer 54 has relatively larger or coarser sand particles than sand layer 52. A layer 56 of supporting gravel may then if desired be layered beneath the third sand layer 54 for final passage of the liquid prior to exiting the filter 10.

As shown in the table given below, an experimental filter formed in accordance with the present invention was compared to a plant filter formed as known in the art. The experimental filter indicated in FIG. 2 was sized to have a diameter of 18 inches and a height of 60 inches. The polymeric layer 70 was about three inches in depth. The layer of filter sand 50 had particles sized at about 45-55 mm and was about 18 inches in depth. The flow rate through the experimental filter was about 7.5 gallons/square foot/minute on average. The total hours of operation were 1200 hours. The cycle time of filtration was about 82 hours. 60% of the water volume indicated a clarity better than 0.02 NTU, or national turbidity units.

TABLE 1

| | Experimental Filter | Plant Filter |
|---|---|---|
| Size | 18″ Diameter × | 8′ Diameter × 20′ Tank |
| | 60″ height | |
| Top Layer | 3″ Polymer | 24″ Anthracite |
| Filter Sand | 18″ of .45-.55 mm² | 15-21″ of .45-.55 mm² |
| Hours of Run | about 1200 hours | about 1200 hours |
| Time | | |
| Flow Rate | about 7.5 gal/(ft² · min) | about 2.5 gal/(ft² · min) |
| Cycle Time | 82 hours | 100 hours |
| Clarity | 60% less than 0.02 NTU | 25% less than 0.02 NTU |
| Total Volume | 950,000 gallons | 28,000,000 gallons |
| Filtered | | |

As shown in the table given above, an experimental filter formed in accordance with the present invention was compared to a plant filter formed as known in the art. The experimental filter indicated in FIG. 2 was sized to have a diameter of about 18 inches and a height of about 60 inches. The polymeric layer 70 was about three inches in depth. The layer of filter sand 50 had particles sized at about 45-55 mm and was about 18 inches in depth. The flow rate through the experimental filter was about 7.5 gallons/square foot on average. The total hours of operation were 1200 hours. The cycle time of filtration was about 82 hours. The clarity was about 60% of the volume was less than or better than 0.02 NTU, or national turbidity units.

With regard to clarity as shown in the table, “60% less than 0.02 NTU” or “25% less than 0.02 NTU” is defined as meaning that 60% of the total volume of water has clarity better than 0.02 NTU, or, that 25% of the total volume of water had clarity better than 0.02 NTU, respectively. The results

The plant filter indicated in Table 1 was sized at about eight feet by about 20 feet. The layer of anthracite was about 24 inches in depth. The filter sand was about 21 inches in depth and sized at about 45-55 mm. The flow rate through the plant filter was about 2.5 gallons per square foot. The cycle time of filtration was about 100 hours. The clarity was about 25% less than or better than 0.02 NTU.

The experimental filter was operated parallel to the plant filter and samples taken simultaneously. Water was supplied from ground wells having a relatively high hardness content of 300 ppm. Lime treatment was used to reduce the hardness. The city utilizing the plant filter had approximately 100,000 water users. For comparative purposes, an extensive run time of 1200 hours was employed. The average experimental filter run or cycle time was 82 hours before backwashing. The plant filter ran for 100 hours before backwashing. The object of the experiment was to determine if the effluent quality could be improved while concurrently raising the flow rate. It will be appreciated that in general, effluent quality is compromised as flow rates are increased unless more sophisticated filtration is used.

The plant flow rate was maintained at about 2.5 gallons per minute per square foot while the experimental filter was maintained at about 7.5 gallons per minute per square foot. The total amount filtered by the experimental filter was about 950,000 gallons. As shown in FIG. 2, the experimental filter ran 640 hours (out of 1200 total hours) with turbidity better than 0.02 N.T.U. (national turbidity units). In contrast, the plant filter only ran about 260 hours (out of 1200 total hours) with turbidity better than 0.02 N.T.U. Overall, the experimental filter provided water significantly less turbid than the plant filter over the 1200 hour run time. Stated another way, the experimental filter only resulted in about 100 hours of water quality indicating 0.10 N.T.U. On the other hand, the plant filter resulted in about 480 hours of water quality indicating 0.10 N.T.U., notwithstanding substantially lower relative flow rates through the plant filter. It should be appreciated that optimization of coagulating and/or flocculating treatment would likely improve the experimental filter performance indicated by the data presented. For the sake of comparative purposes, the water entering the experimental filter and the plant filter were chemically treated in the same manner.

It can therefore be concluded that as indicated in the present test and as compared to the plant filter, the present or experimental filter provided about 250% or more improvement in the water quality as measured by turbidity. It should further be emphasized that the substantial improvement in turbidity was realized while increasing the experimental filter flow rate to about 300% of the plant filter flow rate. This is certainly unexpected, and counterintuitive to what one of ordinary skill would expect. Typically, improved turbidity is most often achieved by reducing flow rates, increasing chemical treatment, and/or providing additional filtration subsequent to the deep bed filter. All of these options, however, translate into greater operating costs. The present system provides improved water quality at higher flow rates and at relatively lower costs.

While the preferred embodiments of the invention have been described in detail, it will be appreciated by one of ordinary skill in the art that the instant invention is susceptible of various modifications without departing from the scope of the following claims.

I claim:

1. A deep bed filter comprising:
a first layer of sand particles for filtration of an influent;
a second layer of cylindrical polymeric particles superimposed over said layer of sand particles, said cylindrical particles having a diameter of approximately 1.5 millimeters, and a specific gravity of approximately 1.15; and
a third layer intermediate of said first and second layers wherein said third layer comprises a significant mixture of said cylindrical polymeric particles and said sand particles.

2. A deep bed filter as claimed in claim 1 wherein said polymeric particles are comprised of polypropylene composite particles.

3. A deep bed filter as claimed in claim 1 wherein said polymeric particles are 6 to 12 inches in depth.

4. A deep bed filter comprising:
a first layer of sand particles for filtration of an influent;
a second layer of cylindrical polymeric particles superimposed over said layer of sand particles, said cylindrical particles having a diameter of approximately 1.5 millimeters, a length in the range of 6 to 1 2 millimeters, and a specific gravity of approximately 1.15; and
a third layer intermediate of said first and second layers wherein said third layer comprises a significant mixture of said cylindrical polymeric particles and said sand particles formed upon backwashing of said first and second layers.

5. A deep bed filter comprising:
a first layer of sand particles for filtration of an influent; and
a second layer of cylindrical polymeric particles superimposed over said layer of sand particles, said cylindrical particles having a diameter of approximately 1.5 millimeters, a length in the range of 6 to 12 millimeters, and a specific gravity of approximately 1.15; and
a means for backwashing the filter and forming a significant mixture of said first and second layers, said mixture intermediate of said first and second layers.
